(19) United States
(12) Patent Application Publication
(10) Pub. No.: US 2010/0260477 A1
(43) Pub. Date: Oct. 14, 2010

(54) METHOD FOR PROCESSING A SUBTITLE DATA STREAM OF A VIDEO PROGRAM, AND ASSOCIATED VIDEO DISPLAY SYSTEM

(76) Inventors: Xia Zhang, Wuhu (CN); Chao Yan, Hefei (CN)

Correspondence Address: NORTH AMERICA INTELLECTUAL PROPERTY CORPORATION, P.O. BOX 506, MERRIFIELD, VA, 22116, US

(21) Appl. No.: 12/488,597

(22) Filed: Jun. 22, 2009

(30) Foreign Application Priority Data
Apr. 14, 2009 (CN) 200910134337.0

(51) Int. Cl. H04N 5/91; G06K 9/18

(52) U.S. Cl. 386/95; 382/182; 386/E05.001

(57) ABSTRACT

A method for processing a subtitle data stream of a video program includes: receiving the subtitle data stream, wherein subtitle data carried by the subtitle data stream is originally stored with an image format; performing optical character recognition (OCR) on the subtitle data carried by the subtitle data stream in order to derive a subtitle text stream; and processing the subtitle text stream to generate a processed subtitle image, and tagging the processed subtitle image onto an image of the video program. An associated video display system including a demultiplexer and a processing module is also provided.

### BACKGROUND

The present invention relates to subtitle processing of a digital television (TV) or a digital TV receiver, and more particularly, to a method for processing a subtitle data stream of a video program, and to an associated video display system.

When a user is viewing a TV program that is played back with a language that is not his/her own native language, the user may rely on subtitles of the TV program to understand the conversations in the TV program. Sometimes the subtitles are not clearly displayed. Although the TV program can be broadcasted digitally, when the subtitles are originally stored with an image format, the display quality of the subtitles may still be unqualified due to various reasons.

For example, the text size utilized for storing the subtitles with the image format is too small, causing the final display quality of the subtitles to be degraded. In another example, the resolution utilized for storing the subtitles with the image format does not match with the display resolution of the TV program, causing the final display quality of the subtitles to be unacceptable. If the video display system utilized for displaying the TV program comprises a TV receiver and a display device, such as a projector, a plasma display panel (PDP) or a liquid crystal display (LCD) panel, resolution mismatch between the TV receiver and the display device may exist, causing the displayed subtitles to be greatly distorted.

As mentioned, as long as the subtitles are originally stored with the image format, no matter whether subtitle data of the subtitles can be separately transmitted or not, the final display quality of the subtitles cannot be guaranteed. In addition, when the subtitles are substantially encoded as respective partial images within a plurality of images of the TV program, the displayed subtitles will become even worse, causing an unpleasant viewing experience for the user.

### SUMMARY

It is therefore an objective of the claimed invention to provide a method for processing a subtitle data stream of a video program and to provide an associated video display system, in order to solve the above-mentioned problem.

An exemplary embodiment of a method for processing a subtitle data stream of a video program comprises: receiving the subtitle data stream, wherein subtitle data carried by the subtitle data stream is originally stored with an image format; performing optical character recognition (OCR) on the subtitle data carried by the subtitle data stream in order to derive a subtitle text stream; and processing the subtitle text stream to generate a processed subtitle image, and tagging the processed subtitle image onto an image of the video program.

An exemplary embodiment of a video display system comprises a demultiplexer and a processing module. The demultiplexer is arranged to demultiplex a television (TV) data stream of a video program into a subtitle data stream and a video stream, wherein subtitle data carried by the subtitle data stream is originally stored with an image format. In addition, the processing module is arranged to perform OCR on the subtitle data carried by the subtitle data stream in order to derive a subtitle text stream, process the subtitle text stream to generate a processed subtitle image, and tag the processed subtitle image onto an image of the video program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video display system according to a first embodiment of the present invention.

FIG. 2 is a flowchart of a method for processing a subtitle data stream of a video program according to one embodiment of the present invention.

FIG. 3 illustrates an example of a processed subtitle image that is tagged onto an image of the video program by the method shown in FIG. 2.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

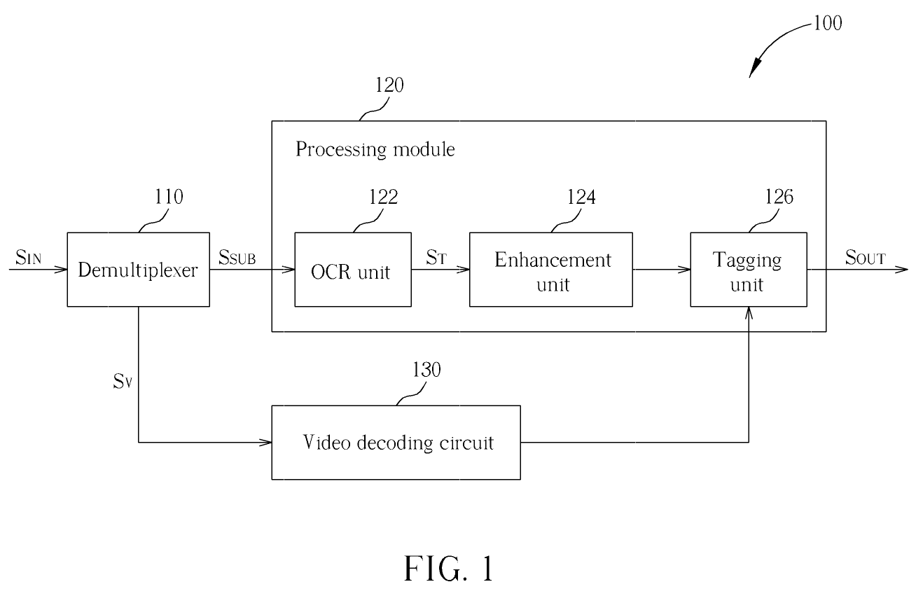

Please refer to FIG. 1. FIG. 1 is a diagram of a video display system 100 according to a first embodiment of the present invention, where the video display system 100 can be a Digital Video Broadcasting (DVB) system or an Advanced Television Systems Committee (ATSC) system. As shown in FIG. 1, the video display system 100 comprises a demultiplexer 110, a processing module 120 and a video decoding circuit 130, where the processing module 120 of this embodiment comprises an optical character recognition (OCR) unit 122, an enhancement unit 124 and a tagging unit 126. In addition, the video display system 100 of this embodiment can be implemented as a digital television (TV) receiver or a digital TV, and comprises a digital tuner (not shown) for receiving broadcasting signals to generate a TV data stream S_{IN} of a video program.

Although the content of the processing module 120 of this embodiment is illustrated as respective sub-blocks within the processing module 120, this is only for illustrative purposes, and is not meant to be a limitation of the present invention. According to a variation of this embodiment, at least a portion of the OCR unit 122, the enhancement unit 124 and the tagging unit 126 can be integrated into the same processing unit and illustrated with the same sub-block.

According to an aspect of this embodiment, the processing module 120 can be implemented with a processing circuit executing a program code, such as a micro processing unit (MPU) executing a firmware code. As a result of such implementation, the processing module 120 shown in FIG. 1 represents the MPU executing the firmware code, while the OCR unit 122, the enhancement unit 124 and the tagging unit 126 shown in FIG. 1 represent functional blocks of respective firmware code modules of the firmware code.

According to the first embodiment, the demultiplexer 110 is arranged to demultiplex the aforementioned TV data stream of the video program into a subtitle data stream S_{SUB} and a video stream S_{V}, wherein subtitle data carried by the subtitle data stream S_{SUB} is originally stored with an image format such as that mentioned above. The video decoding circuit 130 of this embodiment may comprise an MPEG video decoder and/or some other image processor(s) (not shown) for decoding image data of a plurality of images of the video program. Thus, the video decoding circuit 130 decodes the image data carried by the video stream S_{V} to generate decoded data representing video content of the images of the video program, and output the decoded data to the processing module 120. As a result, the processing module 120 processes the subtitle data stream S_{SUB} and outputs an output signal S_{OUT} carrying resultant image data to be displayed, where the resultant image data is generated according to the subtitle data stream S_{SUB} and the decoded data from the video decoding circuit 130.

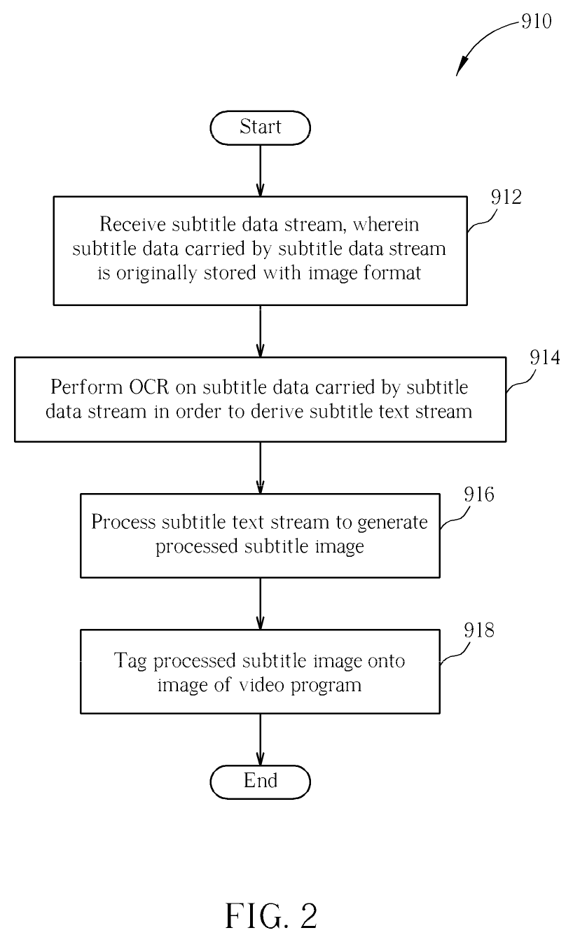

Please refer to FIG. 2. FIG. 2 is a flowchart of a method 910 for processing a subtitle data stream of a video program according to one embodiment of the present invention. The method 910 can be applied to the video display system 100 shown in FIG. 1, and the processing module 120 especially. In addition, the method 910 can be implemented by utilizing the video display system 100, and more particularly, by utilizing the processing module 120 such as the MPU executing the firmware code. Thus, the method 910 is described with the first embodiment as follows.

In Step 912, the OCR unit 122 of the processing module 120 receives the subtitle data stream S_{SUB}, wherein the subtitle data stream S_{SUB} is separated from the video stream S_{V} of the video program. According to this embodiment, the subtitle data carried by the subtitle data stream S_{SUB} is originally stored with an image format such as that mentioned above.

In Step 914, the OCR unit 122 of the processing module 120 performs OCR on the subtitle data carried by the subtitle data stream S_{SUB} in order to derive a subtitle text stream S_{T}.

In Step 916, the enhancement unit 124 of the processing module 120 processes the subtitle text stream S_{T} to generate a processed subtitle image. According to this embodiment, the enhancement unit 124 converts the subtitle text stream S_{T} into a processed text stream, and generates the processed subtitle image according to the processed text stream mentioned above. Thus, the enhancement unit 124 changes a text font, a text size or a text color of at least a portion of a subtitle represented by the subtitle data.

In Step 918, the tagging unit 126 of the processing module 120 tags the processed subtitle image mentioned above onto an image of the video program, such as an image to be displayed.

According to this embodiment, the processing module 120 performs image analysis on a region of the image of the video program with the region being utilized for displaying the portion of the subtitle, and the enhancement unit 124 of the processing module 120 dynamically changes the text font, the text size or the text color of the portion of the subtitle according to color(s) or brightness of the region.

More particularly, the processing module 120 performs image analysis on a plurality of regions within a horizontal band in the bottom of the image to be displayed. For example, the height of the horizontal band can be approximately a quarter or one-fifth of the height of the image to be displayed. As a result, the enhancement unit 124 of the processing module 120 dynamically changes the text font, the text size or the text color of the portion of the subtitle according to color(s) or brightness of each of the regions mentioned above.

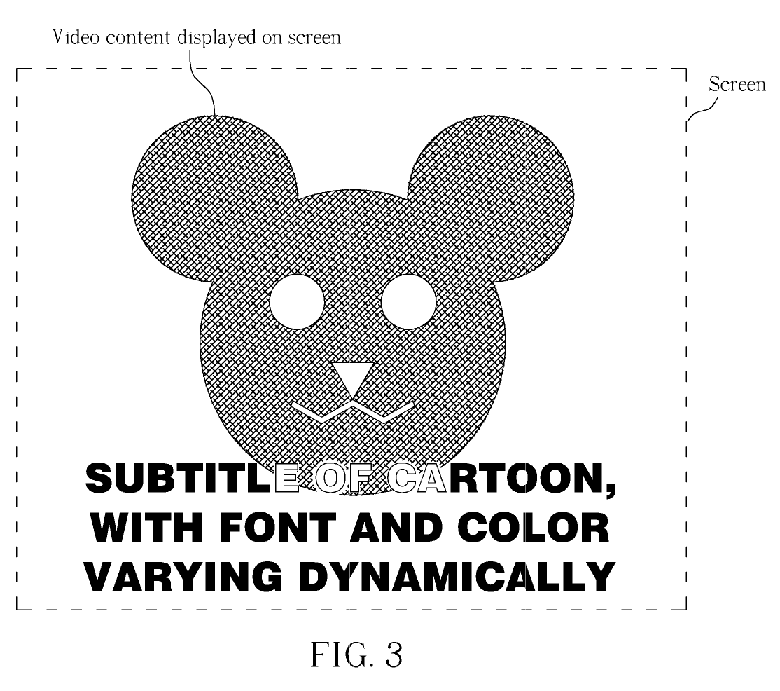

FIG. 3 illustrates an example of the aforementioned processed subtitle image that is tagged onto the image of the video program by the method 910 shown in FIG. 2. Within the content of the subtitle illustrated in FIG. 3 (i.e., “SUBTITLE OF CARTOON, WITH FONT AND COLOR VARYING DYNAMICALLY”), some of the characters have their font and color varied dynamically in accordance with the video content displayed on a screen. In addition, compared to the original size utilized for the subtitle data originally stored with the image format, the size of each character of the subtitle is enlarged. Therefore, the subtitle is enhanced.

According to a variation of this embodiment, in Step 916, the enhancement unit 124 of the processing module 120 converts the subtitle text stream into the processed text stream by generating additional information corresponding to contents of the subtitle text stream and by inserting the additional information into the subtitle text stream. For example, the additional information represents a link to a website mentioned in the subtitle. In another example, the additional information represents a translated word or an explanation for a technical term. Similar descriptions for this variation are not repeated in detail here.

According to another variation of this embodiment, in Step 916, the enhancement unit 124 of the processing module 120 converts the subtitle text stream into the processed text stream by translating contents of the subtitle text stream to generate the processed text stream. For example, the subtitle text stream corresponds to a first language, and the processed text stream corresponds to a second language. In another example, where the subtitles are utilized for learning or comprehension purposes, the subtitle text stream corresponds to Simplified Chinese Characters, and the processed text stream corresponds to Traditional Chinese Characters. Similar descriptions for this variation are not repeated in detail here.

According to another variation of this embodiment, the image format represents that the subtitle data is originally stored as at least one partial image of the video program and that the partial image is overlapped on an image of the video program, such as an image to be displayed. The method 910 further comprises extracting the partial image by performing image processing to derive the subtitle data stream. For example, the partial image of this variation may represent a horizontal band in the bottom of the image to be displayed. The aforementioned MCU executing a varied version of the firmware code performs OCR on the horizontal band cut from the bottom of the image to be displayed. Although the text of the subtitle is originally overlapped on the video content of the image to be displayed, the OCR will have a good recognition result if the video content is not overly complicated, where a fuzzy algorithm can be applied to the OCR operation mentioned above. Similar descriptions for this variation are not repeated in detail here.

Those skilled in the art will readily observe that numerous modifications and alterations of the device and method may be made while retaining the teachings of the invention.

What is claimed is:

1. A method for processing a subtitle data stream of a video program, the method comprising:
receiving the subtitle data stream, wherein subtitle data carried by the subtitle data stream is originally stored with an image format;
performing optical character recognition (OCR) on the subtitle data carried by the subtitle data stream in order to derive a subtitle text stream; and
processing the subtitle text stream to generate a processed subtitle image, and tagging the processed subtitle image onto an image of the video program.

2. The method of claim 1, wherein the subtitle data stream is separated from a video stream of the video program.

3. The method of claim 2, wherein the method is applied to a Digital Video Broadcasting (DVB) system.

4. The method of claim 2, wherein the method is applied to an Advanced Television Systems Committee (ATSC) system.

5. The method of claim 1, wherein the image format represents that the subtitle data is originally stored as at least one partial image of the video program and that the partial image is overlapped on the image of the video program, and the method further comprises:
extracting the partial image by performing image processing to derive the subtitle data stream.

6. The method of claim 1, wherein the step of processing the subtitle text stream to generate the processed subtitle image further comprises:
changing a text font, a text size or a text color of at least a portion of a subtitle represented by the subtitle data.

7. The method of claim 6, further comprising:
performing image analysis on a region of the image of the video program with the region being utilized for displaying the portion of the subtitle;
wherein the step of changing the text font, the text size or the text color of the portion of the subtitle represented by the subtitle data further comprises:
dynamically changing the text font, the text size or the text color of the portion of the subtitle according to color(s) or brightness of the region.

8. The method of claim 1, wherein the step of processing the subtitle text stream to generate the processed subtitle image further comprises:
converting the subtitle text stream into a processed text stream; and
generating the processed subtitle image according to the processed text stream.

9. The method of claim 8, wherein the step of converting the subtitle text stream into the processed text stream further comprises:
generating additional information corresponding to contents of the subtitle text stream; and
inserting the additional information into the subtitle text stream.

10. The method of claim 8, wherein the step of converting the subtitle text stream into the processed text stream further comprises:
translating contents of the subtitle text stream to generate the processed text stream.

11. A video display system comprising:
a demultiplexer arranged to demultiplex a television (TV) data stream of a video program into a subtitle data stream and a video stream, wherein subtitle data carried by the subtitle data stream is originally stored with an image format; and
a processing module arranged to perform optical character recognition (OCR) on the subtitle data carried by the subtitle data stream in order to derive a subtitle text stream, process the subtitle text stream to generate a processed subtitle image, and tag the processed subtitle image onto an image of the video program.

12. The video display system of claim 11, wherein the video display system is a Digital Video Broadcasting (DVB) system.

13. The video display system of claim 11, wherein the video display system is an Advanced Television Systems Committee (ATSC) system.

14. The video display system of claim 11, wherein the processing module further changes a text font, a text size or a text color of at least a portion of a subtitle represented by the subtitle data.

15. The video display system of claim 14, wherein the processing module performs image analysis on a region of the image of the video program with the region being utilized for displaying the portion of the subtitle, and the processing module dynamically changes the text font, the text size or the text color of the portion of the subtitle according to color(s) or brightness of the region.

16. The video display system of claim 11, wherein the processing module converts the subtitle text stream into a processed text stream, and generates the processed subtitle image according to the processed text stream.

17. The video display system of claim 16, wherein the processing module converts the subtitle text stream into the processed text stream by generating additional information corresponding to contents of the subtitle text stream and by inserting the additional information into the subtitle text stream.

18. The video display system of claim 16, wherein the processing module converts the subtitle text stream into the processed text stream by translating contents of the subtitle text stream to generate the processed text stream.

19. The video display system of claim 11, wherein the video display system is a digital TV receiver.

20. The video display system of claim 11, wherein the video display system is a digital TV.
